(19) United States
(12) Patent Application Publication
(10) Pub. No.: US 2020/0122472 A1
(43) Pub. Date: Apr. 23, 2020

(54) CAP, INK CONTAINER AND IMAGE FORMING APPARATUS

(71) Applicant: KYOCERA Document Solutions Inc., Osaka (JP)

(72) Inventor: Masanobu MAESHIMA, Osaka-shi (JP)

(73) Assignee: KYOCERA Document Solutions Inc., Osaka (JP)

(21) Appl. No.: 16/599,655

(22) Filed: Oct. 11, 2019

(30) Foreign Application Priority Data
Oct. 22, 2018 (JP) 2018-198572

(51) Int. Cl. B41J 2/175; C09D 11/36

(52) U.S. Cl. CPC B41J 2/17523; B41J 2/17513; C09D 11/36; B41J 2/17556; B41J 2/17566; B41J 2/17506

(57) ABSTRACT

A cap closes a spout of an ink pack and is coupled to an ink supply target to communicate the ink supply target with the ink pack. The cap includes a communication path, an opening/closing valve, a backflow prevention valve and an annular protrusion. The communication path is communicated with a supply port through which an ink is supplied to the ink supply target. The opening/closing valve opens and closes the supply port. The backflow prevention valve prevents a backflow of the ink from the communication path to the ink pack. The opening/closing valve comes into contact with the annular protrusion with a liquid pressure of the ink filled in the communication path between the opening/closing valve and the backflow prevention valve. The protrusion is tapered toward the supply port.

### INCORPORATION BY REFERENCE

This application is based on and claims the benefit of priority from Japanese patent application No. 2018-198572 filed on Oct. 22, 2018, which is incorporated by reference in its entirety.

### BACKGROUND

The present disclosure relates to a cap which closes a spout of an ink container, an ink container whose spout is closed by the cap, and an image forming apparatus including the ink container.

In an inkjet type image forming apparatus, a recording head ejects an ink on a recording medium, such as a paper sheet, to form an image on the recording medium. The image forming apparatus is provided with an ink container storing the ink, and the ink is supplied from the ink container to the recording head which is a supply target. It is required for the ink container to prevent ink leakage during ink supplying or during transportation.

A ink cartridge (the ink container) is sometimes configured such that an ink supplying port formed in a container is closed with a seal. In the ink cartridge, an ink supplying needle communicated with the recording head is made to penetrate through the seal and to supply the ink from the container to the recording head through the ink supplying needle.

In the case where the seal is used, when the ink supplying needle penetrates through the seal, the seal piece broken by the ink supplying needle may be mixed with the ink in the container as a foreign matter. Additionally, because it is difficult to make the ink supplying port large, there is a problem that a supplying amount of the ink is restricted.

### SUMMARY

In accordance with an aspect of the present disclosure, a cap closes a spout of an ink pack and is coupled to an ink supply target to communicate the ink supply target with the ink pack. The cap includes a communication path, an opening/closing valve, a backflow prevention valve and an annular protrusion. The communication path is communicated with a supply port through which an ink is supplied to the ink supply target. The opening/closing valve opens and closes the supply port. The backflow prevention valve prevents a backflow of the ink from the communication path to the ink pack. The opening/closing valve comes into contact with the annular protrusion with a liquid pressure of the ink filled in the communication path between the opening/closing valve and the backflow prevention valve. The protrusion is tapered toward the supply port.

In accordance with an aspect of the present disclosure, an ink container includes an ink pack and a case. The ink pack has a spout which is closed by the cap. The case stores the ink pack.

In accordance with an aspect of the present disclosure, an image forming apparatus includes the ink container and an image forming part which forms an image using the ink of the ink pack of the ink container.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an inner structure of a printer according to one embodiment of the present disclosure.

FIG. 2 is a perspective view showing an ink container according to the embodiment of the present disclosure.

FIG. 3 is a perspective view showing an ink pack, a spout and a cap of the ink container according to the embodiment of the present disclosure.

FIG. 4 is a perspective view showing the spout and the cap of the ink container according to the embodiment of the present disclosure.

FIG. 5 is a cross sectional view showing the spout and the cap of the ink container according to the embodiment of the present disclosure.

FIG. 6 is a cross sectional view showing the spout and the cap when an ink is supplied, in the ink container according to the embodiment of the present disclosure.

FIG. 7 is a cross sectional view schematically explaining a difference of a tapered angle of a protrusion, in the ink container according to the embodiment of the present disclosure.

### DETAILED DESCRIPTION

Hereinafter, an image forming apparatus, an ink container and a cap according to an embodiment of the present disclosure will be described with reference to the drawings.

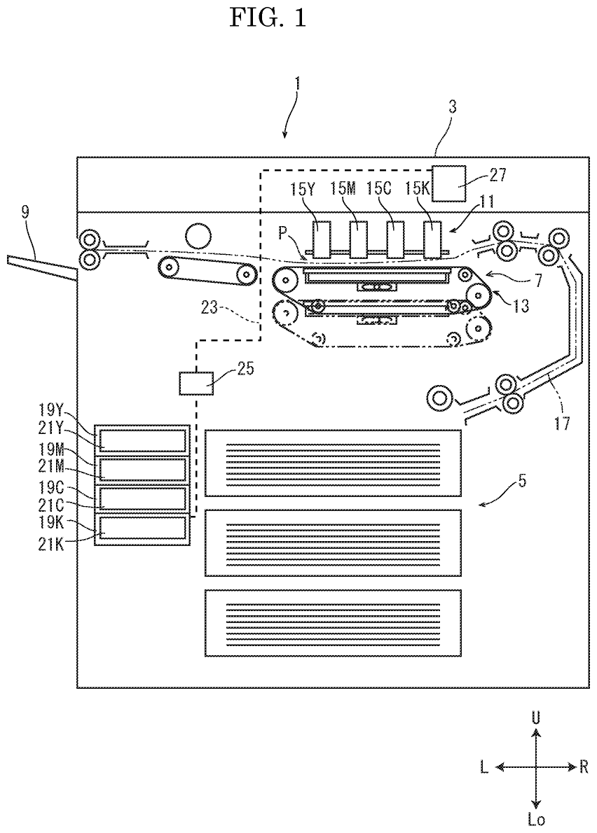

Firstly, with reference to FIG. 1, an entire structure of a printer 1 as the image forming apparatus will be described. For convenience for explanation, a near side (a front side) of a paper surface of FIG. 1 is defined to be a front side of the printer 1. In each figure, L, R, U and Lo respectively show a left side, a right side, an upper side and a lower side of the printer 1.

An apparatus main body 3 of the printer 1 is provided with a sheet feeding part 5, an inkjet type image forming part 7 and a discharge tray 9. The sheet feeding part 5 is disposed in a lower portion of the apparatus main body 3, and includes a plurality of sheet feeding cassettes which store a sheet and a plurality of sheet feeding devices which feed the sheet from the respective sheet feeding cassettes. The image forming part 7 is disposed above the sheet feeding part 5, and includes a head unit 11 and a conveyance unit 13.

The head unit 11 includes four recording heads 15 (15K, 15C, 15M and 15Y) corresponding to four colors (black, cyan, magenta and yellow) respectively. The four recording heads 15 are disposed side by side in the left-and-right direction. The conveyance unit 13 is supported so as to be upwardly and downwardly moved between an upper position close to the head unit 11 and a lower position separate from the head unit 11. When a printing operation is performed, the head unit 13 is moved upwardly to form an image forming path P between the head unit 11 and the conveyance unit 13 from the right side to the left side in FIG. 1. In the apparatus main body 3, a conveyance path 17 for the sheet is formed from the sheet feeding part 5 to the discharge tray 9 through the image forming path P.

In the apparatus main body 3, four ink container storage parts 19 (19K, 19C, 19M and 19Y) are formed side by side in the upper-and-lower direction. The four ink container storage parts 19K, 19C, 19M and 19Y store ink containers 21K, 21C, 21M and 21Y containing black, cyan, magenta and yellow inks, respectively. The ink container will be described later. Each ink container storage part 19 has a receiving port 19a to which the ink is supplied from the ink container 21. The receiving port 19a is connected to the head unit 11 through an ink supply path 23. The ink supply path 23 is provided with a pump 25 and a sub-tank 27 in the order from the upstream side in the ink supply direction.

When the ink container 21 is stored in the corresponding ink storage part 19, the ink container 21 is connected to the receiving port 19a by a coupling structure (not shown). Then, when the pump 25 is driven, the ink is supplied to the ink supply path 23 from the ink container 21 through the receiving port 19a. After that, after stored in the sub-tank 27 temporarily, the ink is supplied to the corresponding recording head 15. That is, the recording head 15 is a supply target to which the ink is supplied from the ink container 21.

Next, a printing operation (an image forming operation) of the printer 1 having the above configuration will be described. When the printer 1 receives an image data from an external computer or the others, the sheet is fed from the sheet feeding part 5 to the conveyance path 17. Then, when the sheet passes the image forming path P, each recording head 15 ejects the ink based on the image date, and a color ink image is formed on the sheet. The color ink image is dried by a dryer (not shown) while the sheet is being conveyed along the conveyance path 17. After that, the sheet is discharged to the discharge tray 9.

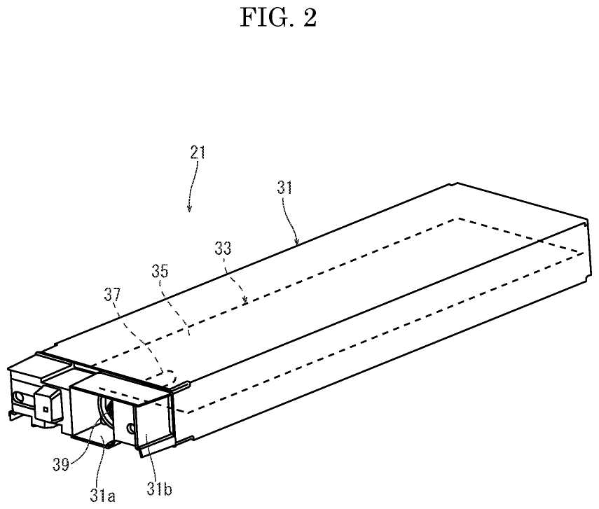

Next, the ink container 21 will be described with reference to FIG. 2. FIG. 2 is a perspective view showing the ink container. The four ink containers 21K, 21C, 21M and 21Y have the same structure, and one ink container among them will be described in the following description.

The ink container 21 includes a case 31 and an ink pack 33 stored in the case 31.

The case 31 is formed in a shallow parallelepiped box-like shape having a size capable of being stored in the ink container storage part 19. On one end face of the case 31, a rectangular opening 31a is formed. Around the opening 31a, a rectangular cylindrical attachment wall 31b is formed. On the other end face of the case 31, an insertion opening (not shown) through which the ink pack 33 is attached is formed.

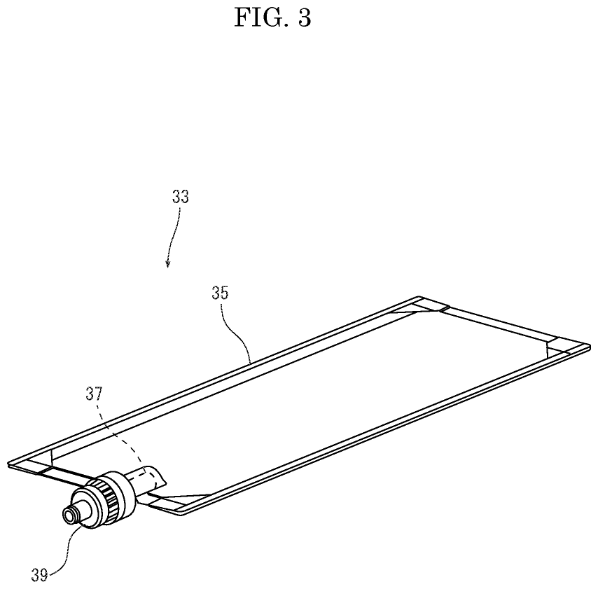

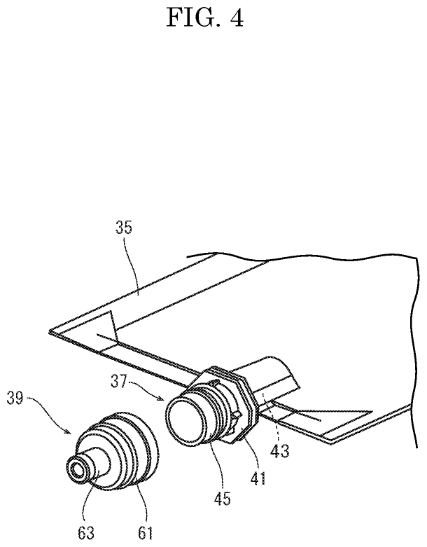

The ink pack 33 will be described with reference to FIG. 2, FIG. 3 and FIG. 4. FIG. 3 is a perspective view showing the ink pack and FIG. 4 is a perspective view showing one end portion of the ink pack.

The ink pack 33 includes a bag body 35, a spout 37 and a cap 39. As shown in FIG. 3, the bag body 35 is a gusset type bag formed by rectangular upper and lower films, and a pair of side films. Each side film is folded along the longitudinal center line. The films are connected to each other by welding. When the bag body 35 is filled with the ink, the folded side films are unfolded and the bag body 35 is expanded to an approximately parallelepiped shape. At this time, by a length of the unfolded portion of the side films, the bag body 35 is reduced in length. On the other hand, when the ink is discharged, the side films are folded, the upper and lower films are overlapped with each other, and the bag body 35 is increased in length.

Each film is made of flexible film material. The film material is formed by laminating two or more layers, such as resin and aluminum. For example, the film material is formed by laminating a polyester layer, an aluminum layer, a nylon layer and a low density polyethylene layer in the order from the front side. Using the polyester layer as a front side layer improves an appearance and a strength of the bag body 35. Using the aluminum layer improves a gas barrier performance of the bag body 35 to heighten an ink storage performance. Using the nylon layer improves a mechanical strength and an impact resistance of the bag body 35. Using the low density polyethylene layer or a polypropylene layer as a back side layer (the innermost layer) heightens a welding strength when the films are formed in a bag-shape by welding, and improves a seal performance.

The spout 37 is held between one end portions of the upper film and the lower film of the bag body 35, and welded to both the films. The cap 39 closes the spout 37. The spout 37 and the cap 39 will be described later.

When the ink pack 33 is stored in the case 31 through the insertion opening, as shown in FIG. 2, the spout 37 closed by the cap 39 is exposed through the opening 31a of the case 31.

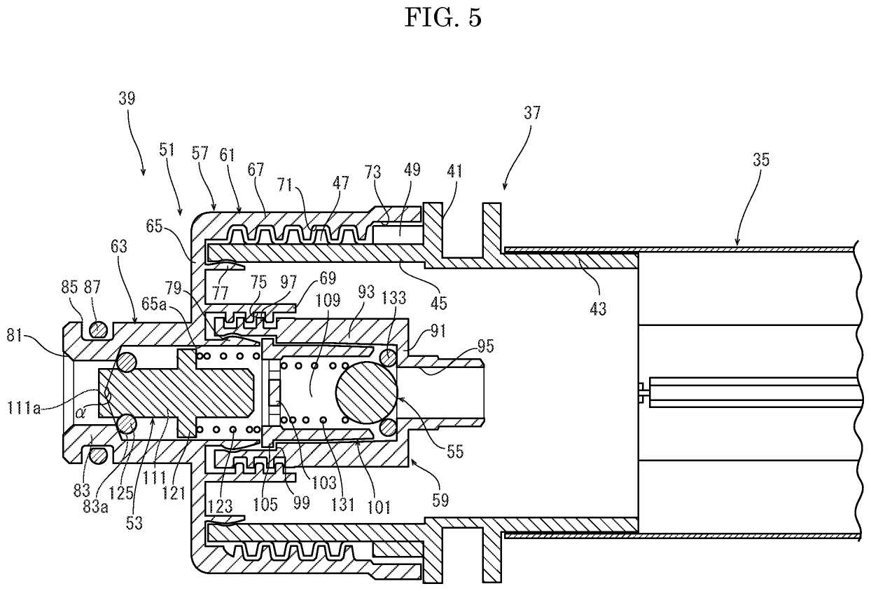

Next, with reference to FIG. 4 and FIG. 5, the spout 37 and the cap 39 will be described. FIG. 5 is a cross sectional view showing the spout and the cap.

Firstly, the spout 37 will be described. The spout 37 is a cylindrical member having a hollow space. The spout 37 has a fixed part 41 fixed to the case 31. The fixed part 41 is formed on the approximately axial center portion of the outer circumferential face along the circumferential direction. The fixed part 41 has two ribs formed at intervals in the axial direction. A fixed part (not shown) of the case 31 is held between the two ribs. Then, the spout 37 is fixed to the case 31.

The spout 37 has a container side end part 43 on one side of the fixed part 41 and a cap side end part 45 on the other side of the fixed part 41. As shown in FIG. 4, the container side end part 43 is held between the upper film and the lower film of the bag body 35 and welded to both the films. This communicates the inside of the bag body 35 with the hollow space of the spout 37. As shown in FIG. 5, on the outer circumferential face of the cap side end part 45, a first male screw 47 and a protruded portion 49 are formed. The protruded portion 49 is formed adjacent to the fixed part 41 on a part of the outer circumferential face along the circumferential direction. The first male screw 47 is formed around the outer circumferential face on the tip end side of the protruded portion 49 (on an opposite side to the bag body 35).

Next, the cap 39 will be described. As shown in FIG. 5, the cap 39 includes a cap main body 51, an opening/closing valve 53 and a backflow prevention valve 55 which are stored in the cap main body 51.

Firstly, the cap main body 51 will be described. The cap main body 51 includes a main body 57 and a sub-main body 59 which is assembled to the main body 57.

The main body 57 has an attachment part 61 attached to the spout 37 and a connection part 63 connected to the ink container storage part 19 (refer to FIG. 4).

The attachment part 61 is formed in a bottomed cylindrical shape, and has an end wall 65, an outer cylindrical wall 67 and an inner cylindrical wall 69. The end wall 65 has a flat ring-shape having a circular opening 65a at the center portion. The end wall 65 has an outer diameter slightly larger than an outer diameter of the cap side end part 45 of the spout 37.

The outer cylindrical wall 67 is formed along the outer circumference of the end wall 65. On the inner circumferential face of the outer cylindrical wall 67, a first female screw 71 and a recess 73 are formed. The first female screw 71 is capable of being meshed with the first male screw 47 of the spout 37. The recess 73 is engageable with the protruded portion 49 of the spout 37.

The inner cylindrical wall 69 is formed around the opening 65a slightly outside the opening 65a. The inner cylindrical wall 69 has a length shorter than a length of the outer cylindrical wall 67. Around the inner circumferential face of the inner cylindrical wall 69, a second female screw 75 is formed.

The attachment part 61 has further an outer seal 77 and an inner seal 79 which are formed on the end wall 65. The outer seal 77 is formed in a cylindrical shape inside the outer cylindrical wall 67 via a small gap. When the first male screw 47 of the spout 37 is meshed with the first female screw 71 of the outer cylindrical wall 67, the outer seal 77 tightly comes into contact with the inner circumferential face of the cap side end part 45. Thereby, a gap between the cap main body 51 and the spout 37 are liquid-tightly sealed so as to prevent leakage of the ink. The inner seal 79 is formed in a cylindrical shape along the opening 65a of the end wall 65 via a small gap with the inner cylindrical wall 69.

The connection part 63 is formed in a cylindrical shape along the opening 65a of the end wall 65. A tip opening of the connection part 63 forms an ink supply port 81. On the inner circumferential face of the tip end portion of the connection part 63, a protrusion 83 is formed. The protrusion 83 is annularly formed inside the supply port 81 along the circumferential direction. The inner side end face 83a of the protrusion 83 (the face on an opposite side to the supply port 81) is inclined to be tapered toward the supply port 81. In a cross sectional view along the axial direction of the connection part 63, imaginary lines extending the end face 83a are crossed at a tapered angle α of 120°. On the outer circumferential face of the tip end portion of the connection part 63, a recess is annularly formed along the circumferential direction. In the recess 85, an O-ring 87 is stored.

The sub-main body 59 has a bottomed cylindrical shape, and has a circular end wall 91 and a cylindrical circumferential wall 93. The end wall 91 has a cylindrical inflow port 95 at the center portion. The circumferential wall 93 has a predetermined inner diameter and a predetermined outer diameter. The inner diameter is almost equal to a diameter of the opening 65a of the end wall 65 of the main body 57. The outer diameter is smaller than an inner diameter of the inner cylindrical wall 69 of the main body 57. Around the outer circumferential face of the circumferential wall 93, a second male screw 97 is formed on the opposite side end portion to the inflow port 95. The second male screw 97 is capable of being meshed with the second female screw 75 of the inner cylindrical wall 69 of the main body 57. On the inner circumferential face of the circumferential wall 93, a step portion 99 is protruded inwardly along the circumferential direction.

In the sub-main body 59, an auxiliary cylinder 101 is stored. The auxiliary cylinder 101 has an outer diameter smaller than an inner diameter of the circumferential wall 93 of the sub-main body 59. In the one end side opening of the auxiliary cylinder 101, a grid stopper 103 is formed. On the outer circumferential face of the auxiliary cylinder 101, an annular portion 105 is protruded outwardly around the one end side opening. The auxiliary cylinder 101 is stored in the sub-main body 59, and the annular portion 105 comes into contact with the step portion 99.

The sub-main body 59 is assembled to the main body 57 by meshing the second male screw 97 with the second female screw 75 of the inner cylinder wall 69 of the main body 57. At this time, the inner seal 79 of the main body 57 enters inside the circumferential wall 93 of the sub-main body 59 and comes into contact with the inner circumferential face of the circumferential wall 93. The tip end of the inner seal 79 comes into contact with the annular portion 105 of the auxiliary cylinder 101. Thereby, a gap between the main body 57 and the sub-main body 59 are liquid-tightly sealed. When the main body 57 and the sub-main body 59 are assembled, a communication path 109 is formed from the inflow port 95 of the sub-main body 59 through the hollow space of the sub-main body 59 (the hollow space of the auxiliary cylinder 101) and the hollow space of the connection part 63 to the supply port 81 of the connection part 63.

Next, the opening/closing valve 53 will be described. The opening/closing valve 53 includes an approximately columnar main body 111 and an O-ring 125 as an annular elastic member. The main body 111 has a length shorter than a length between the annular portion 105 of the auxiliary cylinder 101 stored in the sub-main body 59 of the cap main body 51 and the supply port 81 of the connection part 63. The main body 111 has an outer diameter smaller than an inner diameter of the protrusion 83. Around the approximately axial center portion of the outer circumferential face of the main body 111, an annular flange 121 is formed. The flange 121 has an outer diameter smaller than an inner diameter of the connection part 63 and larger than an inner diameter of the protrusion 83. The O-ring 125 is attached around the end portion of the outer circumferential face of the main body 111 on a side of the tip end face 111a of the main body 111.

The opening/closing valve 53 is stored in the connection part 63 with the tip end face 111a of the main body 111 on the side of the supply port 81. Between the flange 121 of the opening/closing valve 53 and the annular portion 105 of the auxiliary cylinder 101 stored in the sub-main body 59, a valve biasing spring 123 as a first biasing member is disposed. The valve biasing spring 123 biases the opening/closing valve 53 toward the supply port 81 with respect to the auxiliary cylinder 101 (the sub-main body 59), and the O-ring 125 comes into contact with the end face 83a of the protrusion 83. Then, the opening/closing valve 53 closes the supply port 81.

Next, the ball 55 as a backflow prevention valve 55 will be described. The ball 55 is a spherical member having a diameter smaller than an inner diameter of the auxiliary cylinder 101 stored in the sub-main body 59 and larger than an inner diameter of the inflow port 95.

The ball 55 is stored in the auxiliary cylinder 101. Between the stopper 103 of the auxiliary cylinder 101 and the ball 55, a ball biasing spring 131 as a second biasing member is disposed. The ball 55 is biased by the ball biasing spring 131 toward the inflow port 95, and comes into contact with the end wall 91 of the sub-main body 59 via an O-ring 133. Then, the ball 55 closes the inflow port 95.

When the spout 37 is closed by the cap 39 having the above described configuration, the attachment part 61 of the cap 39 is attached to the cap side end part 45 of the spout 37, and then the cap 39 is turned in a closing direction with respect to the spout 37. Then, the first male screw 47 is meshed with the first female screw 71, and the cap 39 is attached to the spout 37. The protruded portion 49 is inserted in the recess 73 to prevent the cap 39 from being turned in an opening direction with respect to the spout 37.

Next, a way to fill the above described ink pack 33 with the ink will be described. Firstly, in a state where the cap 39 is detached, the bag body 35 is filled with the ink through the spout 37. At this time, the ink is filled in the hollow space of the spout 37. Then, the cap 39 is attached to the spout 37 by meshing the first female screw 71 of the cap 39 with the first male screw 47 of the spout 37. At this time, as described above, the gap between the attachment part 61 of the cap 39 and the cap side end part 45 of the spout 37 are liquid-tightly sealed by the outer seal 77.

In the cap 39, as described above, the opening/closing valve 53 is biased by the valve biasing spring 123 toward the supply port 81, and the O-ring 125 comes into contact with the end face 83a of the protrusion 83 to close the supply port 81. The ball 55 is biased by the ball biasing spring 131 toward the inflow port 95, and comes into contact with the end wall 91 of the sub-main body 59 via the O-ring 133 to close the inflow port 95. That is, the communication path 109 between the opening/closing valve 53 and the ball 55 is hollow.

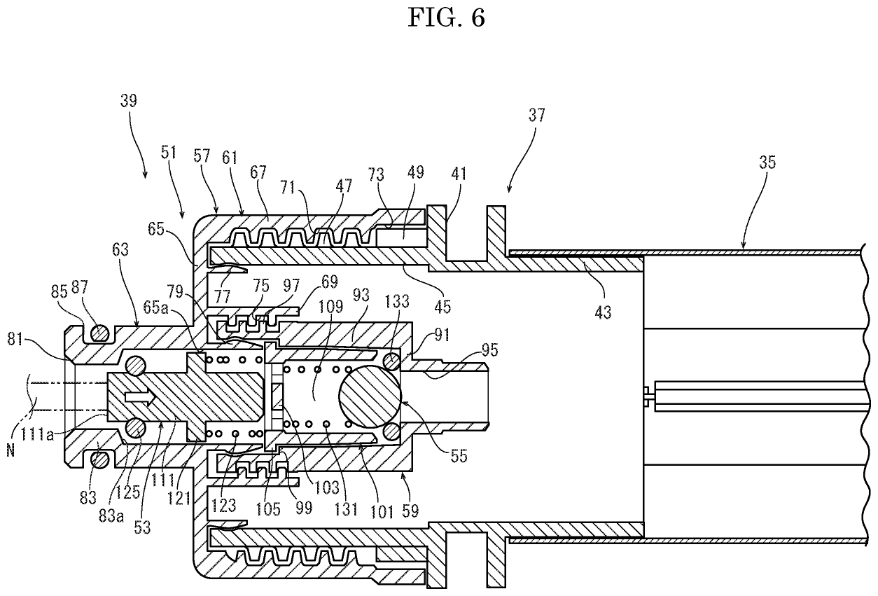

Next, by using an air vent tool, air is removed from the ink pack 33. As shown in FIG. 6, the air vent tool includes a needle N and a suction pump, for example. The needle N is formed to be connected to the connection part 63 of the cap 39 and insertable in the communication path 109 through the supply port 81. The pump sucks the air through the needle N. The needle N is connected to the connection part 63, inserted in the connection part 63 through the supply port 81 and comes into contact with the tip end face 111a of the main body 111 of the opening/closing valve 53. Then, when the needle N is forcefully pushed into the connection part 63, the opening/closing valve 53 is pushed in against a biasing force of the valve biasing spring 123 (refer to a void arrow in FIG. 6). Then, the O-ring 125 is separated from the end face 83a of the protrusion 83 to open the supply port 81, and the communication path 109 is communicated with the pump of the air vent tool.

Then, when the pump is driven to remove the air in the communication path 109 through the needle N, the ball 55 is moved toward the supply port 81 against a biasing force of the ball biasing spring 131, and the O-ring 133 is separated from the end wall 91 of the sub-main body 59. Then, the inflow port 95 is opened and the communication path 109 is communicated with the hollow space of the spout 37 and the inside of the bag body 35. The ink in the hollow space of the spout 37 and the inside of the bag body 35 enters in the communication path 109 through the inflow port 95, is flowed through the communication path 109 toward the air vent tool from the supply port 81.

When the ink is only discharged after the air is removed from the communication path 109 and the communication path 109 is filled with the ink only, the drive of the pump is stopped and the needle N is detached from the connection part 63. Then, the opening/closing valve 53 is biased by the valve biasing spring 123 toward the supply port 81, and the O-ring 125 comes into contact with the end face 83a of the protrusion 83. Additionally, the ball 55 is biased by the ball biasing spring 131 toward the inflow port 95, and the O-ring 133 comes into contact with the end wall 91 of the sub-main body 59. Thereby, the supply port 81 is closed by the opening/closing valve 53 and the inflow port 95 is closed by the ball 55, and the communication path 109 is sealed with filled with the ink.

As described above, according to the ink container 21 of the present disclosure, the opening/closing valve 53 comes into contact with the protrusion 83 of the connection part 63 with a liquid pressure of the ink stored in the communication path 109. The ink is hardly changed in volume even if a pressure is added because it is liquid. Accordingly, owing to the liquid pressure of the ink, it becomes possible to seal the communication path 109 surely. In the present embodiment, the O-ring 125 of the opening/closing valve 53 comes into contact with protrusion 83. At this time, the O-ring 125 is deformed in a wedge-shape to bite between the main body 111 of the opening/closing valve 53 and the end face 83a of the protrusion 83 so that the sealing performance can be further improved. However, the main body 111, but not the O-ring 125, may directly come into contact with the protrusion 83.

As described above, unless the opening/closing valve 53 is pushed in with a strong force like a case where the ink container 21 is attached to the ink container storage part 19, the opening/closing valve 53 is not moved. In other words, the opening/closing valve 53 is not moved by such a force generated when the ink container 21 is vibrated during transportation or external pressure is applied to the opening/closing valve 53 so that it becomes possible to prevent the ink leakage.

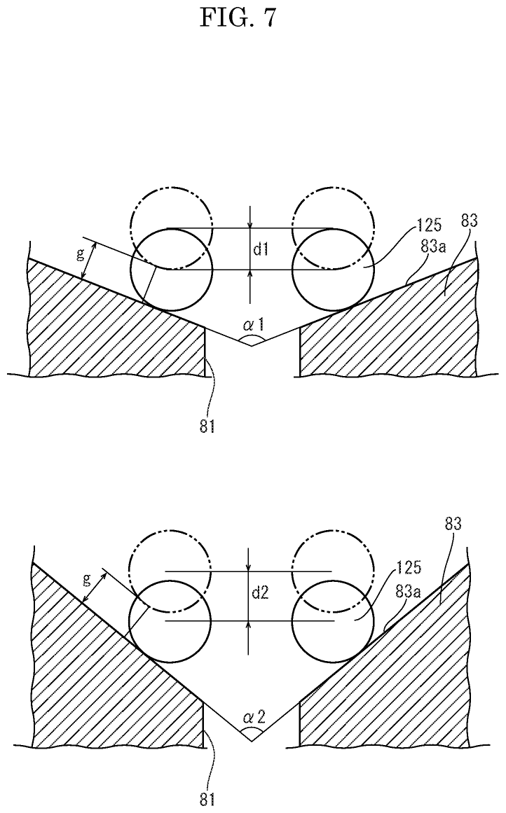

The end face 83a of the protrusion 83 with which the O-ring 125 of the opening/closing valve 53 comes into contact is formed such that a tapered angle α is 120°. The tapered angle α is preferably from 60° to 120°. A relationship between a tapered angle α and a gap between the O-ring 125 and the end face 83a will be described with reference to FIG. 7. FIG. 7 is a view schematically showing the O-ring and the protrusion. The main body 111 of the opening/closing valve 53 is not shown in FIG. 7.

An upper figure of FIG. 7 shows a case where the tapered angle α1 is large and a lower figure of FIG. 7 shows a case where a tapered angle α2 is smaller than a tapered angle α1. A shift distance of the O-ring 125 for forming a predetermined gap between the O-ring 125 and the end face 83a is smaller in a case where a tapered angle α1 is large (a shift distance is d1) than in a case where a tapered angle α2 is small (a shift distance is d2). That is, as the tapered angle α is larger (as the tapered angle α is more obtuse), it becomes possible to form the gap with a small shift distance. On the other hand, the O-ring 125 is deformed in a wedge-shape to bite between the main body 111 of the opening/closing valve 53 and the end face 83a of the protrusion 83. At this time, as the tapered angle α is smaller, a degree of the wedge-shaped deformation of the O-ring 125 becomes larger to heighten the sealing performance owing to the deformation of the O-ring 125. That is, the tapered angle α is preferably 120° or smaller because the sealing performance of the O-ring 125 is kept while the shift distance of the O-ring 125 is as small as possible. For example, in a case of the tapered angle α of 130°, the sealing performance of the O-ring 125 is not insufficiently to cause the ink leakage.

Accordingly, a tapered angle α of 60° to 120° makes it possible to close the spout 37 and to prevent the ink leakage, and to supply the ink to the supply target with a suitable force when the spout 37 is connected to the supply target.

When the ink container 21 in which the ink pack 33 is stored is stored in the ink container storage part 19, a needle of a joint (not shown) provided in the ink container storage part 19 is inserted into the connection part 63 from the supply port 81 and pushes in the opening/closing valve 53 to open the supply port 81, in the same manner as the needle of the above-described air vent tool. After that, when the pump 25 (refer to FIG. 1) of the apparatus main body 2 is driven, the inflow port 95 is opened, and the communication path 109 of the cap 39 is communicated with the hollow space of the spout 37 and the hollow space of the bag body 35. Then, the ink is drawn through the communication path 109, stored in the sub-tank 27 temporarily though the ink supply path 23 and then supplied to the recording head 15 as a supply target.

When the ink in the ink pack 33 is consumed and the ink pack 33 is replaced, the ink container 21 is drawn from the container storage part 19. Then, the needle of the ink container storage part 19 is separated from the connection part 63, the force for pushing the opening/closing valve 53 in is released, the opening/closing valve 53 is biased by the valve biasing spring 123 to come into contact with the protrusion 83, and then the supply port 81 is closed. After that, the ink pack 33 is detached from the case 31. At this time, the ink leakage does not occur because the supply port 81 is closed by the opening/closing valve 53. Then, the new ink pack 33 is stored in the case 31.

Although the present disclosure described the specific embodiment, the present disclosure is not limited to the embodiment. It is to be noted that one skilled in the art can modify the embodiment without departing from the scope and spirit of the present disclosure.

1. A cap which closes a spout of an ink pack and is coupled to an ink supply target to communicate the ink supply target with the ink pack, the cap comprising:
a communication path which is communicated with a supply port through which an ink is supplied to the ink supply target;
an opening/closing valve which opens and closes the supply port;
a backflow prevention valve which prevents a backflow of the ink from the communication path to the ink pack; and
an annular protrusion with which the opening/closing valve comes into contact with a liquid pressure of the ink filled in the communication path between the opening/closing valve and the backflow prevention valve,
wherein the protrusion is tapered toward the supply port.

2. The cap according to claim 1,
wherein the protrusion has an end face with which the opening/closing valve comes into contact, and
imaginary lines extending the end face toward the supplying port in a cross section along a communication direction of the communication path are crossed at a tapered angle from 60° to 120°.

3. The cap according to claim 1,
wherein the opening/closing valve includes an annular elastic member pressed against the protrusion.

4. The cap according to claim 1, comprising a first biasing member which biases the opening/closing valve toward the supply port to press the opening/closing against the protrusion.

5. The cap according to claim 1, further comprising an inflow port from the ink pack to the communication path and a second biasing member which biases the backflow prevention valve toward the inflow port.

6. The cap according to claim 1, further comprising an inflow port from the ink pack to the communication path,
wherein the backflow prevention valve is a spherical body having a diameter larger than an inner diameter of the inflow port.

7. An ink container comprising:
an ink pack having the cap according to claim 1; and
a case which stores the ink pack.

8. An image forming apparatus comprising:
the ink container according to claim 7; and
an image forming part which forms an image using the ink of the ink pack of the ink container.
